(19) United States
(12) Patent Application Publication
(10) Pub. No.: US 2008/0086223 A1
(43) Pub. Date: Apr. 10, 2008

(54) SYSTEM AND METHOD FOR EVALUATING A BASEBALL PLAYER

(76) Inventor: MICHAEL PAGLIARULO, WINCHESTER, MA (US)

Correspondence Address: AKC PATENTS, 215 GROVE ST., NEWTON, MA, 02466, US

(21) Appl. No.: 11/867,516

(22) Filed: Oct. 4, 2007

Related U.S. Application Data
(60) Provisional application No. 60/850,440, filed on Oct. 10, 2006.

(51) Int. Cl. G06F 17/30; G06F 19/00

(52) U.S. Cl. 700/91; 235/375; 707/104.1

(57) ABSTRACT

A system for evaluating a baseball player combines data from a proprietary database and graphical evaluation tools of the player's performance. The database contains certified content data from professional scouts for each baseball player. The graphical evaluation tools include Hot Zone and Pitch Zone grids with ratings for each of the grid areas based on a numerical scale. The numerical scale is converted into a color-coded scale and the grids are transformed into colored Hot Zone Grid and Pitch Zone Grids, respectively. The Hot Zone and Pitch Zone Grids are used to evaluate, project and advance scout a baseball player's ability.

### CROSS REFERENCE TO RELATED CO-PENDING APPLICATIONS

This application claims the benefit of U.S. provisional application Ser. No. 60/850,440 filed Oct. 10, 2006 and entitled “SYSTEM AND METHOD FOR EVALUATING A BASEBALL PLAYER”, the contents of which are expressly incorporated herein by reference.

### FIELD OF THE INVENTION

The present invention relates to a system and a method for evaluating a baseball player, and more particularly, to an online system that combines certified content and graphical presentation of the player's performance and provides this information in real time during video streaming of a baseball game.

### BACKGROUND OF THE INVENTION

Baseball is popular team sport in North America, Latin America, the Caribbean, and East Asia. It is a bat and ball game in which a pitcher 54 throws (pitches) a hard, fist-sized ball toward the hitting area of a batter 52, shown in FIG. 1. The batter 52 attempts to hit the baseball with a tapered, smooth, cylindrical bat made of wood or metal. Baseball is played between two teams of nine players each on a baseball field 50. The field 50 is divided into two main sections: The infield, containing the four bases, is for defensive and offensive purposes bounded by the foul lines and the grass line, shown in FIG. 1. The outfield is the grassed area beyond the infield grass line, between the foul lines, and bounded by a wall or fence. The game is played in nine innings in which each team gets one turn to bat and try to score runs while the other pitches and defends in the field. In baseball, the defense always has the ball, a fact that differentiates it from most other team sports. The teams switch every time the defending team gets three players of the batting team out. The winner is the team with the most runs after nine innings. The basic contest is always between the pitcher for the fielding team, and a batter of the batting team. The pitcher throws the ball towards home plate, where the catcher for the fielding team waits to receive it. The batter stands in the batter's box and tries to hit the ball with a bat. The pitcher's main role is to pitch the ball toward home plate with the goal of getting the batter out. Most pitchers use two or three types of pitches. Common pitches include a fastball, which is the ball thrown at high speed; a curveball, which is made to curve by rotation imparted by the pitcher; and a change-up, which seeks to mimic the delivery of a fastball but arrives at significantly lower velocity. With each pitch, the batter must decide whether or not to swing the bat at the ball in an attempt to hit it. The pitches arrive quickly, so the decision to swing must be made in less than a tenth of a second, based on whether or not the ball is hittable and in the strike zone, i.e., a region defined by the area directly above home plate and between the hollow beneath the batter's knee and the midpoint between the top of the shoulders and the top of the uniform pants, shown in FIG. 6.

Baseball is fundamentally a team sport, yet it places individual players under great pressure and scrutiny. The pitcher must make good pitches or risk losing the game and the hitter has a mere fraction of a second to decide what pitch has been thrown and whether or not to swing at it. Baseball's history is full of heroes and goats-men who in the heat of the moment (the “clutch”) distinguished themselves with a timely hit or catch, or an untimely strikeout or error, respectively. Accordingly, evaluating, measuring and predicting the performance of individual baseball players are very important activities in the field of baseball. They are used for player recruiting, coaching and performance improvement purposes, game strategy and prediction purposes and contribute significantly to the overall performance and business success of the teams.

Prior art methods of evaluating individual player performance are based on statistical measures, such as batting average for batters, i.e., the number of hits divided by the number of at bats, and earned run average for pitchers, i.e., approximately the number of runs given up by a pitcher per nine innings. The advent of sabermetrics has brought a new set of statistics that perhaps better gauge a player's performance and contributions to his team from year to year. Some sabermetrics measures include on-base plus slugging (OPS), i.e., a somewhat complicated formula that some say gauges a hitter's performance better than batting average, and walks plus hits per inning pitched (or WHIP) that gives a good representation of a pitcher's abilities. However, these statistical measures are based on historical data and very often fail to predict current and future performance of an individual player. Many people believe that the performance of a baseball player depends upon a combination of skill, timing, athleticism, personality, work habits, team chemistry and strategy, among others. As Yogi Berra (a famous baseball player) once said, “Baseball is 90% mental—the other half is physical.” Accordingly, there is a need for a system that provides both a quantitative and a qualitative way of evaluating a baseball player. Furthermore, in today's sports environment, where most people watch baseball games in televised programs, a real time player performance evaluation and prediction during the video streaming of the game is very desirable.

### SUMMARY OF THE INVENTION

A system for evaluating a baseball player combines data from a proprietary database and graphical evaluation tools of the player's performance. The database contains certified content data from professional scouts for each baseball player. The graphical evaluation tools include Hot Zone and Pitch Zone grids with ratings for each of the grid areas based on a numerical scale of 1-10. The numerical scale is converted into a color-coded scale and the grids are transformed into colored Hot Zone Grid and Pitch Zone Grids, respectively. The Hot Zone and Pitch Zone Grids are used to evaluate, project and advance scout a baseball player's ability.

In general, in one aspect, the invention features a method for evaluating the overall performance of a baseball player including providing a database comprising certified content data about the baseball player, providing a graphical evaluation tool, converting the certified content data into ratings based on a numerical scale and populating the graphical evaluation tool with the numerical ratings.

Implementations of this aspect of the invention may include one or more of the following features. The graphical evaluation tool comprises a grid. The certified content data comprise at least one of biographical data, type of player, playing position data, physical characteristics and skills data, qualitative evaluation reports by certified evaluators or quantitative evaluation reports by certified evaluators. The certified evaluators comprise one of a scout, trainer, athletic director, coach or professional evaluator. The qualitative evaluation reports comprise one or more observations and evaluations of the baseball player's skills in hitting, pitching, throwing, running, leadership skills, team playing skills, work habits, ethics, personality traits or character attributes. The quantitative evaluation reports comprise one or more statistical measure data. The baseball player may be a batter and the graphical evaluation tool comprises a hot zone grid superimposed over an official strike zone comprising a rectangular area above a home plate area and defining boundaries through which a pitch must pass in order to count as a strike when the batter does not swing. The baseball player may be a pitcher and the graphical evaluation tool comprises a pitch zone grid. The hot zone grid may be a six-by-six grid superimposed over the official strike zone and the pitch zone grid may be an inner five-by-five grid of the hot zone grid. The method may further include displaying the graphical evaluation tool with the numerical ratings onto an electronic display screen. The displaying may occur in real-time during streaming of a baseball game. The method may further include displaying a pitch zone grid of a pitcher over a hot zone grid of a batter. The method may further include converting the numerical ratings into color-coded ratings and displaying the graphical evaluation tool with the color-coded ratings onto an electronic display screen.

In general in another aspect the invention features a system for evaluating the overall performance of a baseball player including a database stored in a computer having certified content data about the baseball player and a graphical evaluation tool displayed onto an electronic display screen. The graphical evaluation tool is a grid. The certified content data are converted into ratings based on a numerical scale by a computing circuit and the graphical evaluation tool grid is populated with the numerical ratings.

Implementations of this aspect of the invention may include one or more of the following features. The electronic display screen may be one of a computer screen, a television screen, a mobile phone screen or a PDA screen. The system may further include a first application for converting the certified content data into the numerical ratings and a second application for converting the numerical ratings into color-coded ratings.

### BRIEF DESCRIPTION OF THE DRAWINGS

Referring to the figures, wherein like numerals represent like parts throughout the several views:

FIG. 1 is a diagram of a baseball diamond;

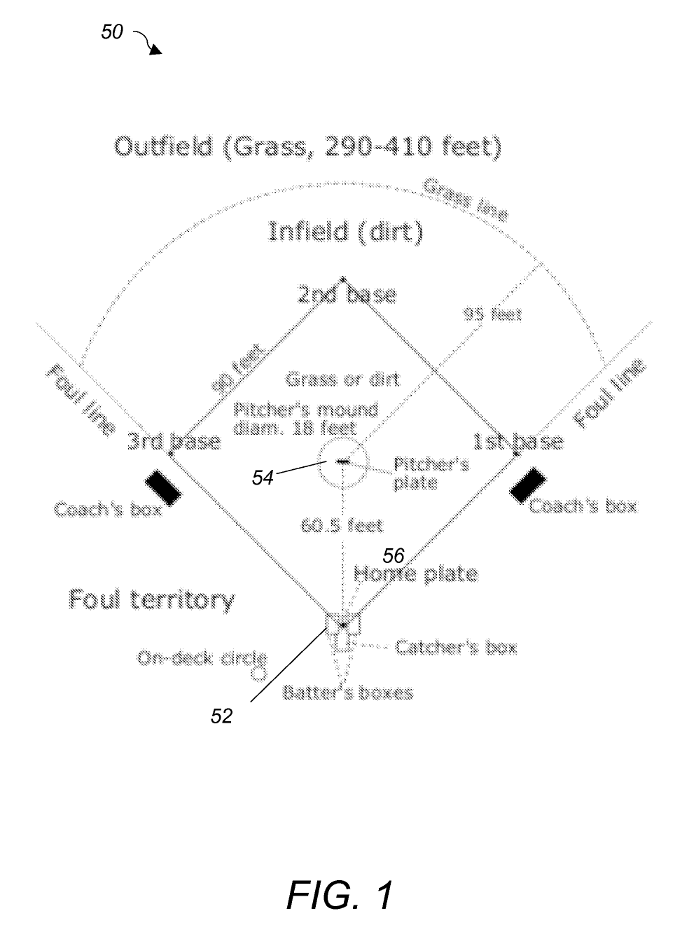

FIG. 2 is an overview diagram of an online system for evaluating a baseball player, according to this invention;

FIG. 3 is a screen shot of the main webpage of the system for evaluating a baseball player of FIG. 1;

FIG. 4 is a screen shot of a webpage of the system of FIG. 2 depicting a list of all baseball players;

FIG. 5 is a screen shot of a webpage of the system of FIG. 2 depicting a report for a specific baseball batting player;

FIG. 6 is a diagram of the official strike zone area;

FIG. 7 is a screen shot of a webpage of the system of FIG. 2 depicting the hot zone ratings for the baseball player of FIG. 5;

FIG. 8 is a flow diagram the process of developing the hot zone rating grid of FIG. 7;

FIG. 9 is a diagram depicting the transformation of the hot zone rating grid into a color coded grid;

FIG. 10 is a screen shot of a webpage of the system of FIG. 2 or entering pitch zone rating data for a baseball pitcher;

FIG. 11 is a screen shot of a webpage of the system of FIG. 2 depicting pitch zone rating data for four different types of pitches for a baseball pitcher;

FIG. 12 is a TV screen shot of a real-time baseball game combined with data streaming form the Turf Dirt Management system of FIG. 2;

FIG. 13 is a TV screen shot of a real time baseball pitching/batting situation combined with the Turf Dirt hot zone rating data for the batter;

FIG. 14 is a TV screen shot of a real time baseball pitching/batting situation combined with the Turf Dirt pitch zone rating data for the pitcher;

FIG. 15 is a match-up of the pitcher's pitch zone rating data with the batter's hot zone rating data; and

FIG. 16 is a block diagram of the process of projecting pitch zone rating data for a pitcher and hot zone rating data for a batter during a real-time video streaming of a baseball pitching/batting situation.

### DETAILED DESCRIPTION OF THE INVENTION

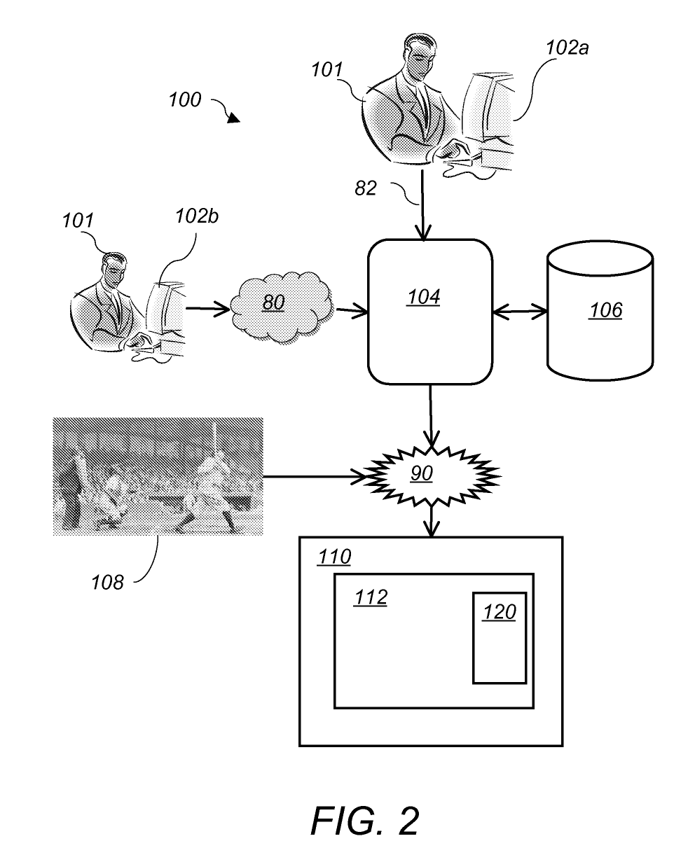

Referring to FIG. 2, an online system 100 for evaluating and predicting the performance of a baseball player includes a server 104, a database 106 and local and remote browsers 102a, 102b, respectively. Server 104 provides bi-directional access to the database 106. Local browser 102a accesses the server 104 and database 106 through a direct connection 82 and remote browser 102b accesses the server 104 and database 106 through a network connection 80. Users 101 enter or review data in the database 106 either through the local browser 102a or through the remote browser 102b. Server 104 has also a network connection 90 to a projection screen 110 and sends data 120 from the database 106 to the projection screen 110. Projection screen 110 also receives and projects data from a live or stored video recording 108 through the same network connection 90. Data 120 from the database 106 and data 112 from the live or stored video recording are projected simultaneously on the projection screen 110. Access to the database 106 is secure and protected with authentication and encryption mechanisms. Users 101 who are allowed to have access to the database 106 include professional scouts, coaches, athletic directors and trainers. In one example, network connection 80 is the Internet and network connection 90 is a major cable TV network. Browsers 102a are application programs that allow the users 101 to download and view webpages on their computers. Webpages contain mark-up language code, such as HTML (Hypertext Mark-up Language) or XML (Extensible Markup Language) which the browser interprets and displays as graphics and text on the computer monitor of the user. Examples of browsers include Microsoft's™ Internet Explorer, Apple's™ Safari and Sun System's™ Netscape Navigator.

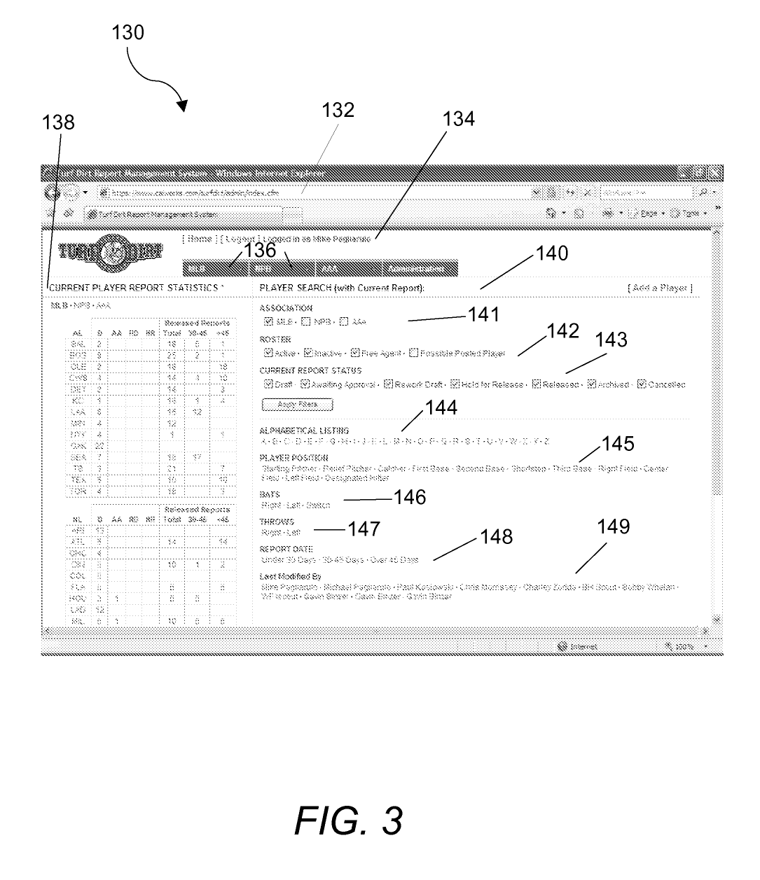

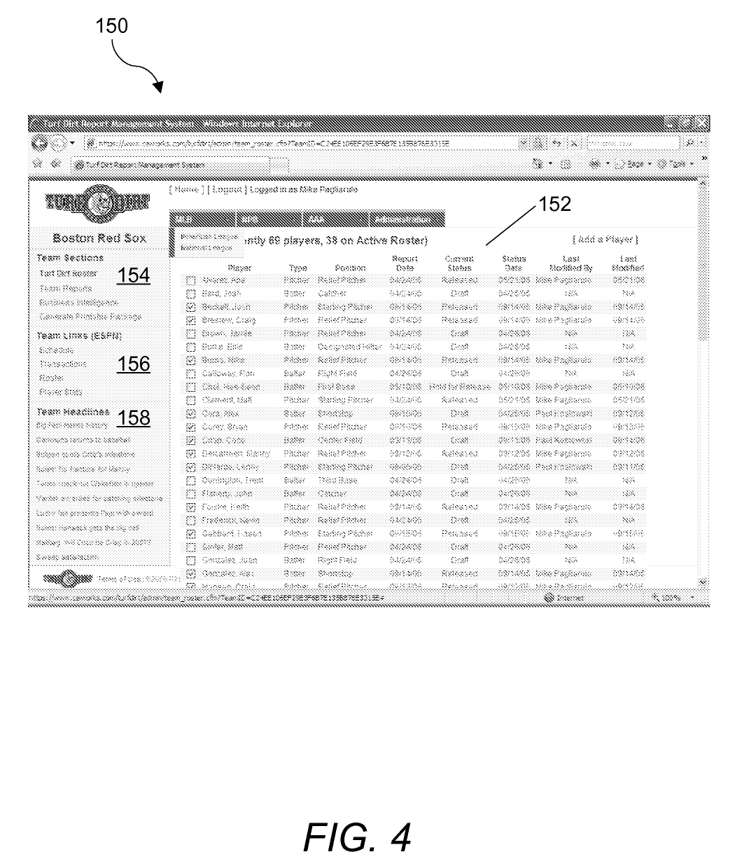

Referring to FIG. 3, a user 101 accesses the Turf Dirt™ webpage 130 for system 100 by entering the URL address 132 of the server 104 in the address segment of the browser. The user is then asked to go through an authentication step for a secure login by providing a username and a password. User 101 needs to register his username and password with the Turf Dirt™ system before being able to receive access privileges. Upon confirmation of the identity and security privileges of the user by the system the user is logged in 134 and is allowed access to the data of database 106. The user may enter a report or data, revise a report or data or review a report or data in the database. Database 106 contains biographical, qualitative and quantitative evaluation reports of players from various major and minor baseball leagues 136 including Major League Baseball (MLB), NPB, AAA among others. Webpage 130 allows the user to search reports for specific players 140 based on league 144, status 142, alphabetical listing 144, player position 145, batting ability and skills 146, throwing ability and skills 147, report date 148 and report author 149, among others. A typical search results webpage 150 includes listings of players 152, team sections 154, team links 156 and team headlines 158, as shown in FIG. 4. A player listing 152 includes the name of the player, type of player, i.e., pitcher or batter and player position, i.e., relief pitcher, catcher, starting pitcher, designated hitter, shortstop, first base, second base, third base, center field, right field and left field. The player listing also includes report information, i.e., date of report, report status, status date, modification date and author of the report. The team section 154 includes the team player roster, team reports and business intelligence. External team links 156 include team schedule, transactions, roster and player status. Team headlines 158 include major newspaper headlines about players, team, coaches and managers, among others.

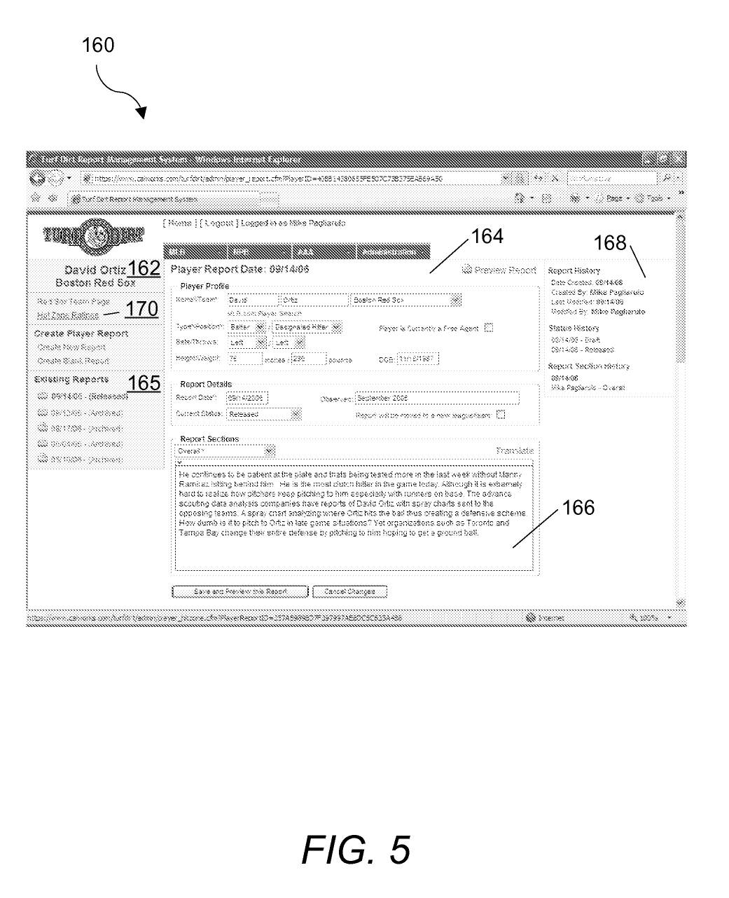

Referring to FIG. 5, a typical player report webpage 160 includes, the player's name, team name, type of player, position of player, batting/throwing abilities and skills, status, height, weight and date of birth. The report webpage also includes date of the report, date the player was observed, report status, report history and author of the report. The report also includes quantitative and qualitative evaluation 166 of the player by a specific scout, trainer, coach or other qualified and certified evaluator. The qualitative evaluation 166 includes observations about the players hitting, pitching, throwing and running abilities, leadership and team playing skills, work habits and ethics, personality and character attributes, among others. The quantitative evaluation includes historical statistical performance measure data, such as RBIs, hits, and home runs, among others.

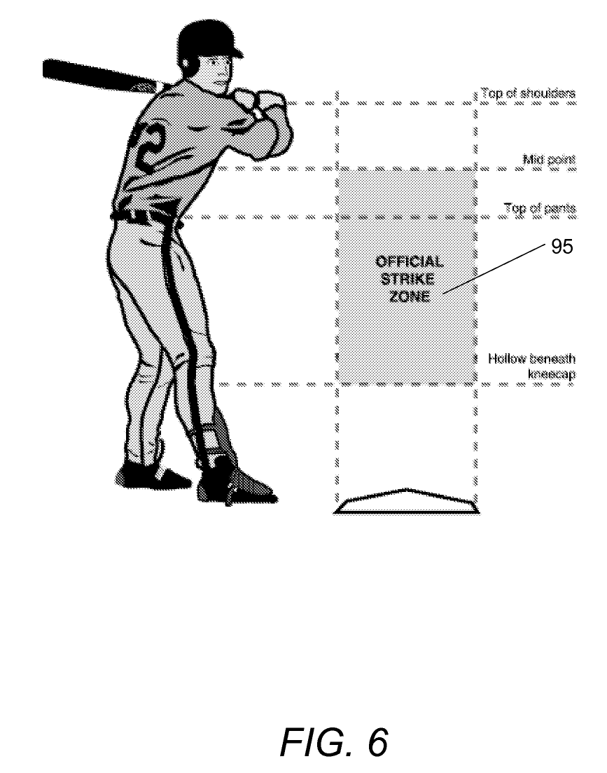

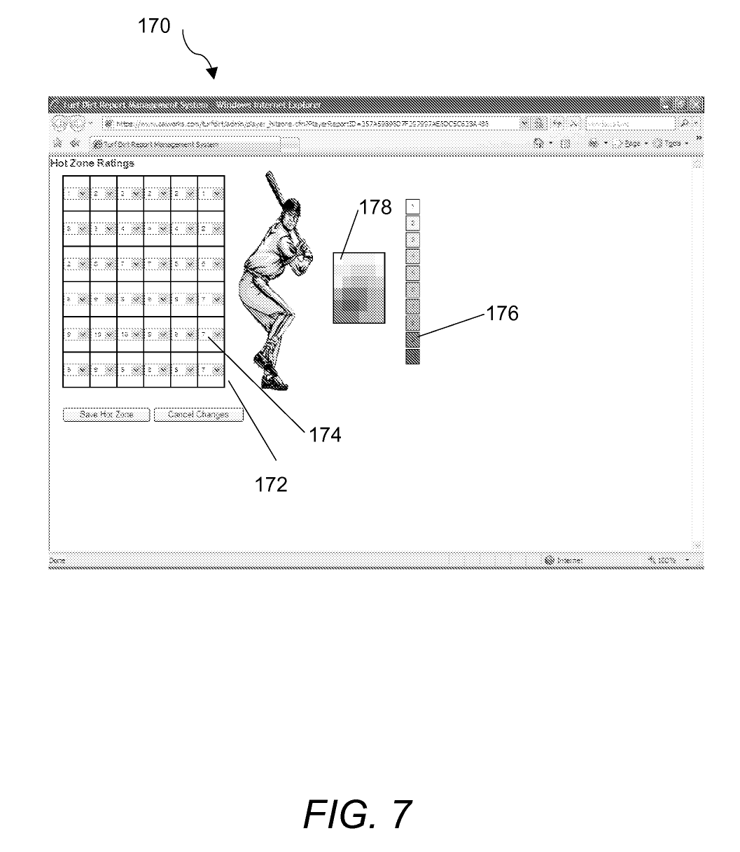

Referring to FIG. 7, a qualitative evaluation tool of the Turf Dirt™ system is the Hot Zone Rating Grid 170. The Hot Zone Rating Grid 170 is constructed by dividing the official strike zone 95, shown in FIG. 6, into a 6×6 grid. In baseball, the official strike zone 95 is a conceptual rectangular area over the home plate, which defines the boundaries through which a pitch must pass in order to count as a strike when the batter does not swing. The top of the strike zone is the mid-level between the top of the batter's shoulders and the top of his pants, and the bottom is at the level just beneath the kneecap. The right and left boundaries of the strike zone correspond to the edges of the home plate 96. The 6×6 grid defines 36 rectangular fields 172. A professional scout, trainer, or coach observes and evaluates the ability of a baseball batter to hit a pitch directed in each one of the 36 rectangular fields and enter a rating grade in each of the 36 fields. In one example, the evaluation scale is from 1 to 10 with 1 being the low rating grade and 10 the high rating grade. The Hot Zone Rating Grid 170 is used to document the performance of a batter.

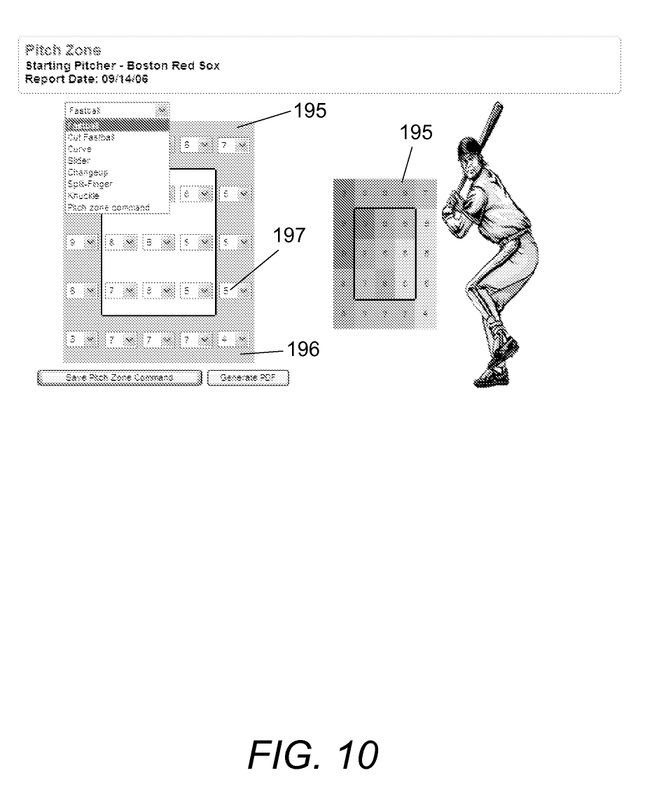

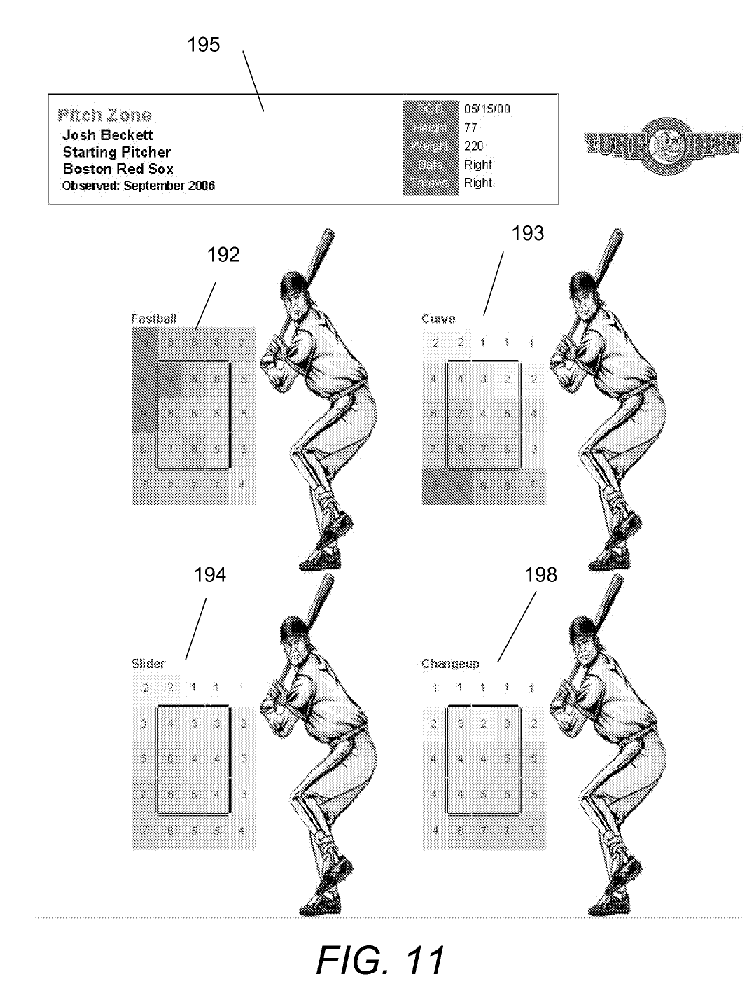

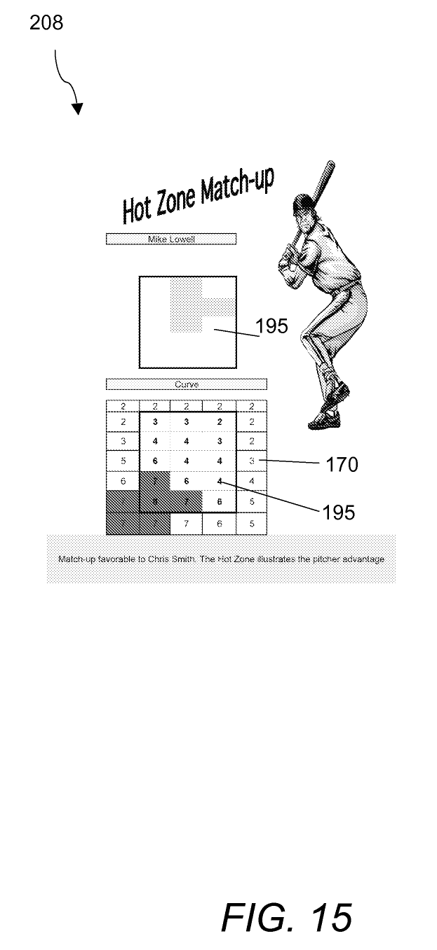

The performance of a baseball pitcher is documented with a Pitch Zone Rating Grid. Referring to FIG. 10, the Pitch Zone Rating Grid 195 is a 5×5 grid defining 25 rectangular fields 196. The pitcher's Pitch Zone Rating Grid 195 is smaller than the batter's Hot Zone Rating Grid 170 and covers the inside 5×5 area of the batter's 6×6 grid, as shown in FIG. 15. The baseball pitcher is evaluated for different types of pitches, including fastball 192, curveball 193, slider 194 and changeup 198, among others, and a the Pitch Zone Rating Grid is constructed for each one of these type of pitches, as shown in FIG. 11.

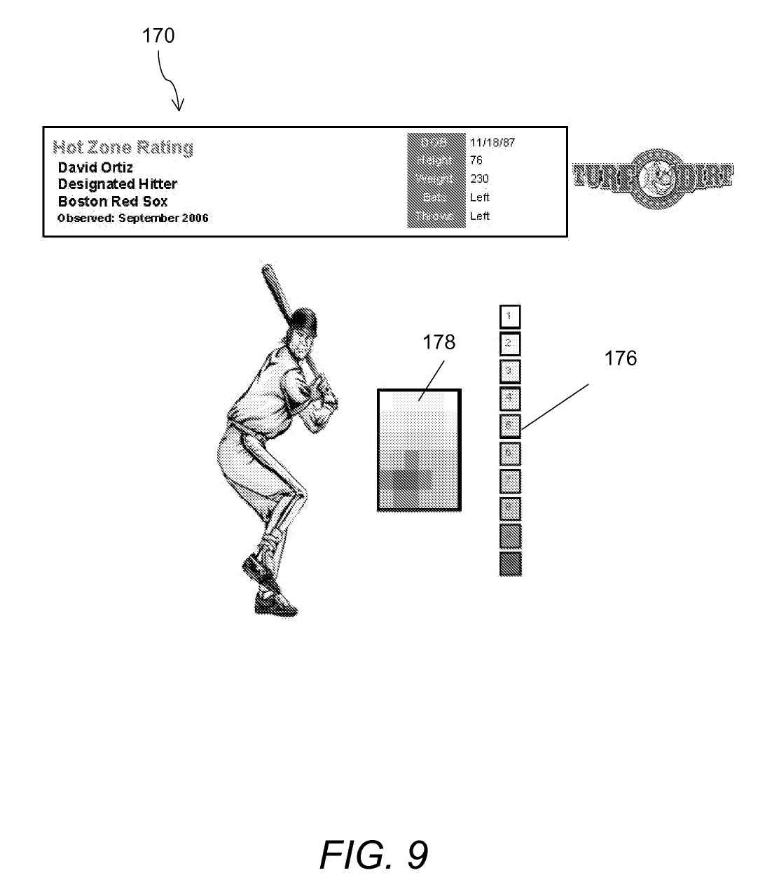

The grading scale of the Hot Zone Rating Grid 170 and the Pitch Zone Rating Grid is transformed into a colored scale 176, with 10 being the darkest color and 1 being the lightest color, and the color coded grids are displayed as a color coded areas 178 on the webpage, as shown in FIG. 9.

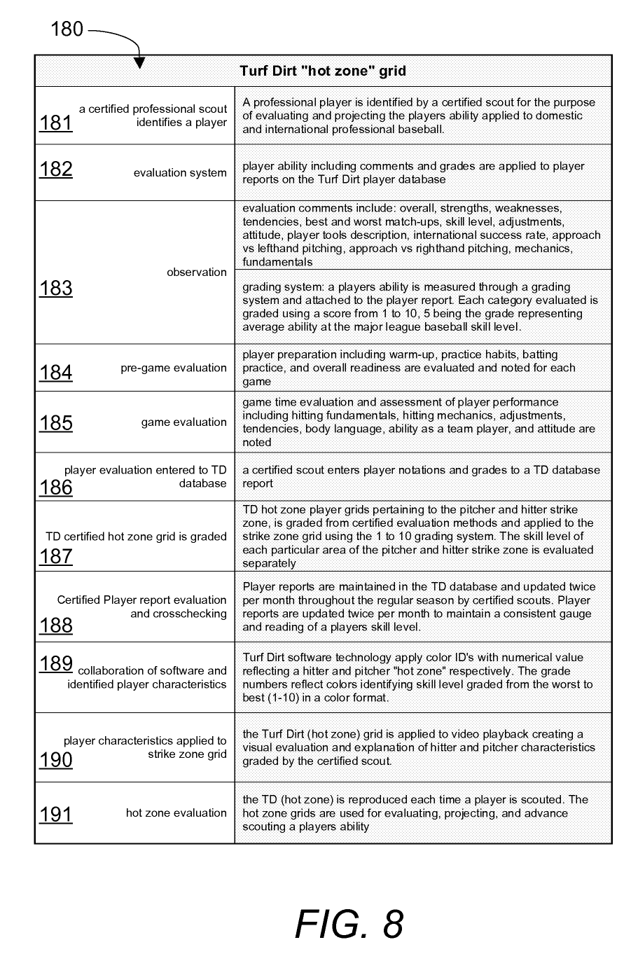

The method of evaluating a player 180 according to this invention is described with reference to FIG. 8. First a certified professional scout or trainer identifies a player to be evaluated (181). The scout enters general information about the player and information about the player's abilities including comments and grade in a report page of the Turf Dirt™ management system (182). Next, the scout observes the player and enters evaluation comments and grades into the system (183). The evaluation comments include overall strength, weaknesses, tendencies, best and worst match-ups, skill level, adjustments, attitude, player tools description, international success rate, approach versus left-hand pitching, approach versus right-hand pitching, mechanics and fundamentals, among others. The player's ability is measured based on the above mentioned 1-10 scale and the grade is attached to the report. The grade 5 represents average ability at the major baseball league skill level. Next, the scout performs a pre-game evaluation of the player for a series of games (184). The pre-game observation and evaluation includes player's preparation, warm-up, practice habits, batting practice, and overall readiness. The scout also evaluates the player during several games (185). The game time evaluation and assessment of the player includes hitting fundamentals, hitting mechanics, adjustments, tendencies, body language, ability as a team player, and attitude. All evaluations are entered into the report page of the Turf Dirt™ management system (186). Based on these inputs the system generates the player's Hot Zone Grid or Pitch Zone Grid (187). Hot Zone Grids and Pitch Zone grids are generated for the batter and pitcher, respectively. Player reports are maintained in the system database 106 and updated twice per month throughout the regular baseball season (188). The player reports are updated twice per month in order to maintain a consistent gauge and reading of the player's skill level. The system then transforms the numeric scale into the color coded scale and generates the color coded Hot Zone Grid 178 or a color coded Pitch Zone Grid (189). During the video streaming of a live or previously taped baseball game the Hot Zone Grid and the Pitch Zone Grid from the database are projected and superimposed upon the strike zone area and are used to explain, and predict the outcome of a specific pitch/hit combination (190). The Hot Zone Grid and Pitch Zone Grid are reproduced every time a player is scouted and is used for evaluating, projecting and advance scouting the player's ability (191).

One example of the Hot Zone Grid 170 for a specific baseball batter is shown in FIG. 9. Examples of the Pitch Zone Grid for a specific baseball pitcher are shown in FIG. 10 for the different types of pitches, including a fastball pitch 192, a curveball pitch 193, a slider pitch 194 and a changeup pitch 198.

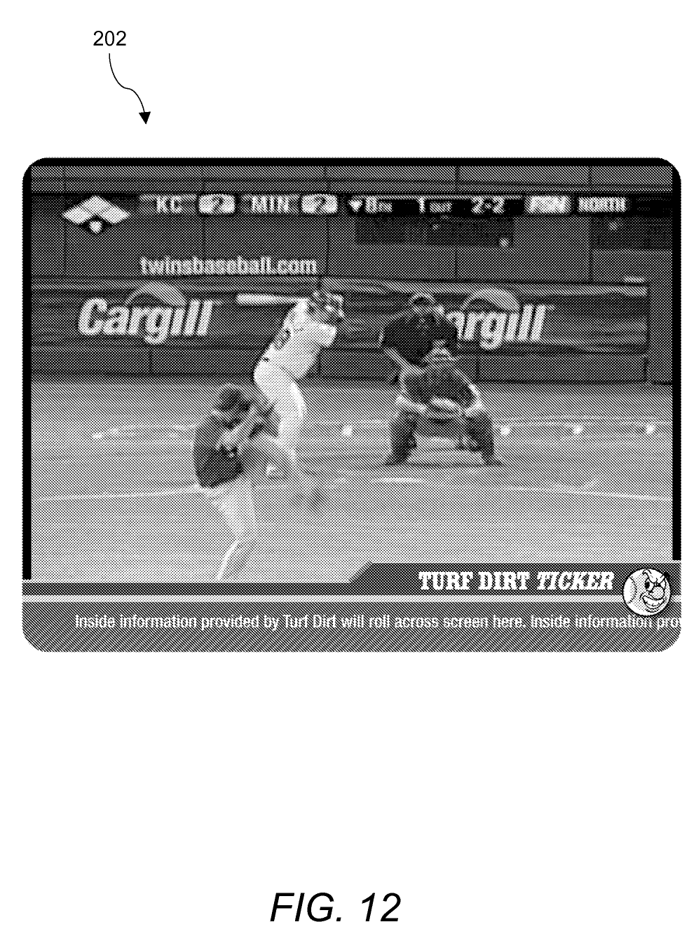

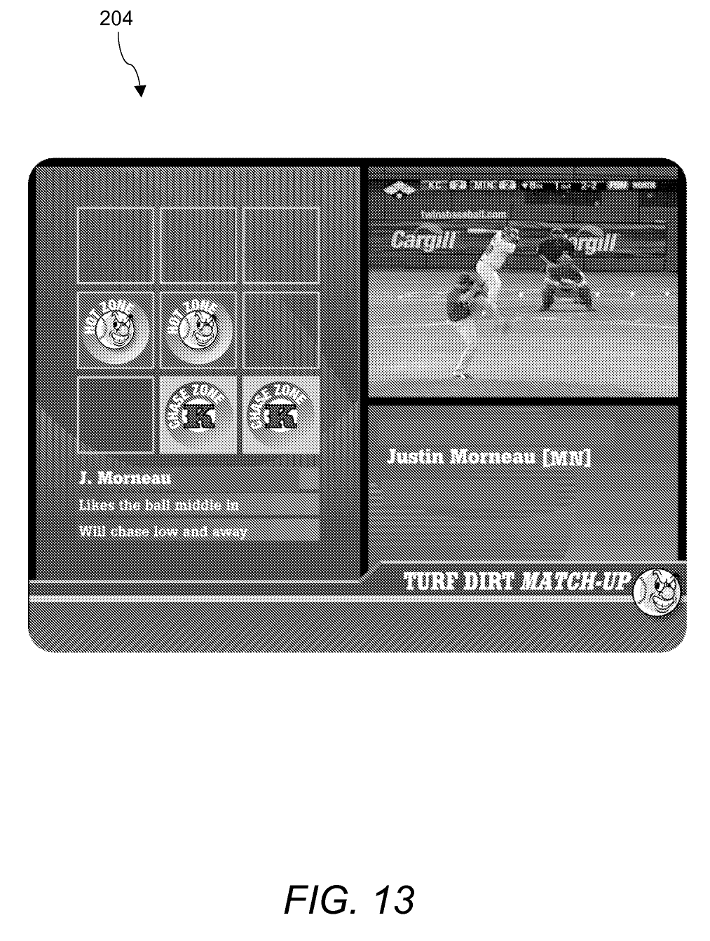

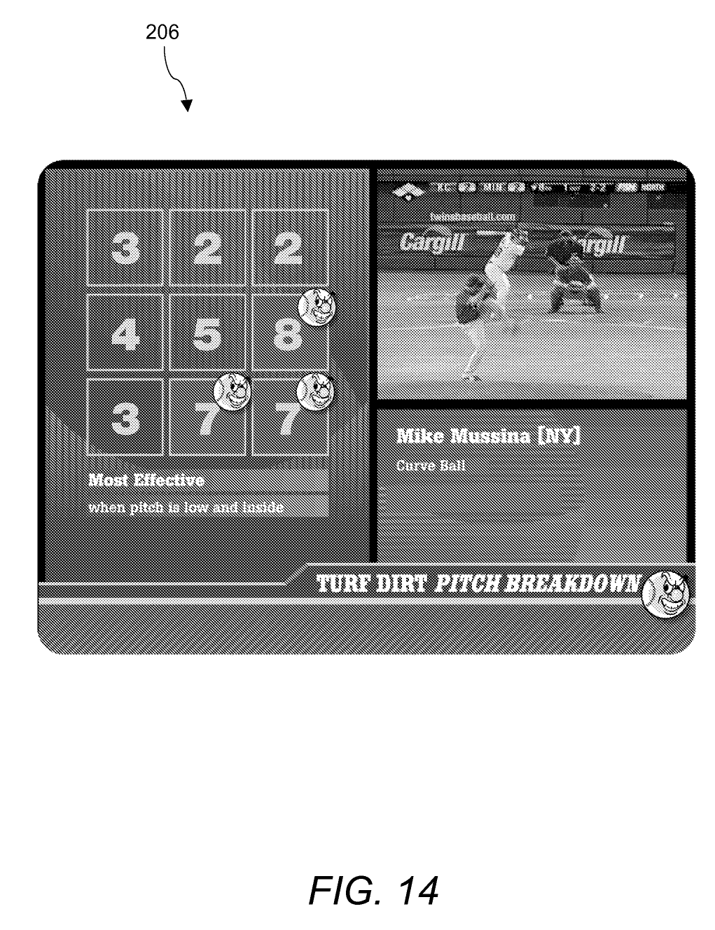

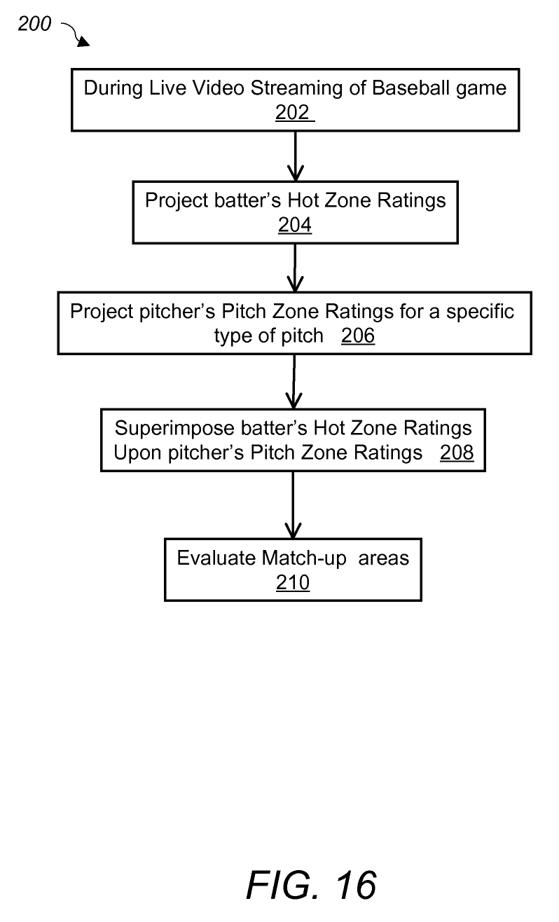

The process 200 of projecting the Hot Zone Grid during a video streaming of a baseball game is described with reference to FIG. 12-16. During live or previously recorded streaming of video of a baseball game (202) the batter's Hot Zone Grid is projected on the TV screen upon the strike zone area (204). At the same time the pitcher's Pitch Zone Grid for a specific type of pitch is projected upon the TV screen (206) and superimposed upon the batter's Hot Zone Grid (208). Based on this type of superposition match-up areas of the Hot Zone areas and Pitch Zone areas are determined (210). FIG. 13 depicts the Hot Zone Grid for a specific baseball batter. According to this grid the batter is effective when the ball is in the middle of the strike zone, and less effective in the low and away areas of the strike zone. FIG. 14 depicts the Pitch Zone Grid for a specific baseball pitcher. According to this grid the pitcher's curveball pitch is effective in the low and inside area of the pitch zone. Superposition of the pitcher's Pitch Zone Grid of FIG. 14 with the batter's Hot Zone Grid of FIG. 13 indicates that the pitcher has an advantage over the batter, as shown in FIG. 15.

In another embodiment the performance of a baseball batter is also evaluated in a plane parallel to the home plate 56. According to this embodiment a Contact Zone Grid is constructed having the dimensions of the home plate and the location of establishing a contact between the bat and the ball is indicated on it. Some batters tend to establish contact in front of the home plate and others in the back of the home plate. By combing the information of the Contact Zone Grid with the information of the Hot Zone Grid a three-dimensional Hot Zone is constructed that covers the volume of a parallelepiped above the home plate.

Other embodiments are within the scope of the following claims. For example, the video streaming of the baseball game may be live or previously recorded. The Hot Zone and Pitch Zone grids may be projected above the home plate in the area of the strike zone during the video streaming or on a divided screen, as shown in FIG. 14. The video streaming of the baseball game and the projection of the Hot Zone and Pitch Zone grids may be viewed in a television screen, a computer screen, a mobile phone or PDA screen, or a direct TV screen. Photographs of the various video screens depicting the Hot Zone and Pitch Zone grids may be printed and viewed in newspapers, magazines, books, baseball cards and other printed forms.

Several embodiments of the present invention have been described. Nevertheless, it will be understood that various modifications may be made without departing from the spirit and scope of the invention. Accordingly, other embodiments are within the scope of the following claims.

What is claimed is:

1. A method for evaluating the overall performance of a baseball player comprising:
providing a database comprising certified content data about said baseball player;
providing a graphical evaluation tool wherein said graphical evaluation tool comprises a grid;
converting said certified content data into ratings based on a numerical scale; and
populating said graphical evaluation tool grid with said numerical ratings.

2. The method of claim 1 wherein said certified content data comprise at least one of biographical data, type of player, playing position data, physical characteristics and skills data, qualitative evaluation reports by certified evaluators or quantitative evaluation reports by certified evaluators.

3. The method of claim 2 wherein said certified evaluators comprise one of a scout, trainer, athletic director, coach or professional evaluator.

4. The method of claim 3 wherein said qualitative evaluation reports comprise one or more observations and evaluations of said baseball player's skills in hitting, pitching, throwing, running, leadership skills, team playing skills, work habits, ethics, personality traits or character attributes.

5. The method of claim 3 wherein said quantitative evaluation reports comprise one or more statistical measure data.

6. The method of claim 1 wherein said baseball player comprises a batter and said graphical evaluation tool comprises a hot zone grid superimposed over an official strike zone comprising a rectangular area above a home plate area and defining boundaries through which a pitch must pass in order to count as a strike when the batter does not swing.

7. The method of claim 6 wherein said baseball player comprises a pitcher and said graphical evaluation tool comprises a pitch zone grid.

8. The method of claim 7 wherein said hot zone grid comprises a six-by-six grid superimposed over said official strike zone and said pitch zone grid comprises an inner five-by-five grid of said hot zone grid.

9. The method of claim 1 further comprising displaying said graphical evaluation tool with said numerical ratings onto an electronic display screen.

10. The method of claim 9 wherein said displaying occurs in real-time during streaming of a baseball game.

11. The method of claim 10 further comprising displaying a pitch zone grid of a pitcher over a hot zone grid of a batter.

12. The method of claim 1 further comprising converting said numerical ratings into color-coded ratings and displaying said graphical evaluation tool with said color-coded ratings onto an electronic display screen.

13. A system for evaluating the overall performance of a baseball player comprising:
a database stored in a computer and comprising certified content data about said baseball player;
a graphical evaluation tool displayed onto an electronic display screen wherein said graphical evaluation tool comprises a grid; and
wherein said certified content data are converted into ratings based on a numerical scale by a computing circuit and said graphical evaluation tool grid is populated with said numerical ratings.

14. The system of claim 13 wherein said electronic display screen comprises one of a computer screen, a television screen, a mobile phone screen or a PDA screen.

15. The system of claim 14 further comprising a first application for converting said certified content data into said numerical ratings and a second application for converting said numerical ratings into color-coded ratings.

16. The system of claim 13 wherein said certified content data comprise at least one of biographical data, type of player, playing position data, physical characteristics and skills data, qualitative evaluation reports by certified evaluators or quantitative evaluation reports by certified evaluators.

17. The system of claim 16 wherein said certified evaluators comprise one of a scout, trainer, coach or professional evaluator.

18. The system of claim 17 wherein said qualitative evaluation reports comprise one or more observations and evaluations of said baseball player's skills in hitting, pitching, throwing, running, leadership skills, team playing skills, work habits, ethics, personality traits or character attributes.

19. The system of claim 18 wherein said quantitative evaluation reports comprise one or more statistical measure data.

20. The system of claim 13 wherein said baseball player comprises a batter and said graphical evaluation tool comprises a hot zone grid superimposed over an official strike zone comprising a rectangular area above a home plate area and defining boundaries through which a pitch must pass in order to count as a strike when the batter does not swing.

21. The system of claim 20 wherein said baseball player comprises a pitcher and said graphical evaluation tool comprises a pitch zone grid.

22. The system of claim 21 wherein said hot zone grid comprises a six-by-six grid superimposed over said official strike zone and said pitch zone grid comprises an inner five-by-five grid of said hot zone grid.

23. The system of claim 22 wherein said graphical evaluation tool with said certified content data is displayed onto said electronic display screen in real-time during streaming of a baseball game.
